(19) United States
(12) Patent Application Publication
(10) Pub. No.: US 2006/0105817 A1
(43) Pub. Date: May 18, 2006

(54) Method and apparatus for capturing phone movement

(75) Inventors: Indran Naick, Cedar Park, TX (US); Jeffrey Kenneth Wilson, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/992,513

(22) Filed: Nov. 18, 2004

(51) Int. Cl. H04M 1/00

(52) U.S. Cl. 455/567; 455/41.2

(57) ABSTRACT

A method, apparatus, and computer instructions for managing alerts. A ring tone is audibly presented to alert the user of the incoming call in response to detecting receipt of the incoming call. A selected movement of the mobile communications device is monitored in response to audibly presenting the ring tone. The volume of the ring tone is reduced without answering the incoming call in response to detecting the selected movement.

### BACKGROUND OF THE INVENTION

1. Technical Field

The present invention relates to an improved data processing system and in particular to a method and apparatus for processing data. Still more particularly, the present invention relates to a method, apparatus and computer instructions for identifying movement of a mobile communications device.

2. Description of Related Art

Mobile phone systems use various transmission protocols, such as a global system for mobile communications (GSM) and Code-Division Multiple Access (CDMA). Mobile phones have proven to be a very beneficial tool for people to exchange information when away from the home or office. Millions of people use mobile phones for talking to others. In addition, these mobile phones are also able to exchange data, such as e-mail messages. A user of mobile phones may send or receive e-mail in a fashion similar to that in a computer. Additionally, a user may also store contact information, make task or to do lists, track appointments, and set reminders using a mobile phone.

Further, users also may obtain information, such as news, entertainment, and stock quotes from the Internet through mobile phones. Mobile phones often also include simple games and may integrate other devices, such as personal digital assistants or MP3 players. Additionally, many mobile phones also incorporate global positioning system (GPS) receivers. As can be seen, with all of these features and functions, mobile phones are widely used devices.

At the same time, mobile phones are becoming a public nuisance due to the generation of ring tones when calls are received. Often times, mobile phones may ring, using a ring tone in inappropriate places, such as stores, restaurants, and other public places. A ring tone is a sound generated by a mobile phone to indicate an incoming call is present. The ring tone may be for example a beep, a ring, or even music. Some methods have been implemented to reduce this problem. For example, silent modes or single beep settings also have been used to reduce the noise nuisance caused by mobile phones.

Additionally, a notion of a slowly increasing volume of a ring tone also has been implemented to provide the user a chance to answer the phone before the ring tone reaches a louder volume.

Each of these methods, however, has a down side. The silent mode requires special steps to initiate this mode. This mode also is considered for special occasions, such as meetings and movies. This mode is not the typical ringer one leaves a mobile phone set on for public places. A single beep ring is not particularly usable if the phone is kept in a purse or a certain location at which the user is unable to hear the beep the first time. As a result, the user may miss a call. Like the silent mode, this setting is not a typical setting in which the user leaves the mobile phone. The issue with an increasing ring volume is that it typically takes longer than a single ring to answer a call. A user may be slow to grab or answer the phone. Further, it also is natural to take a moment to view the caller ID and decide whether or not to answer the call. All of these actions occur while the ring tone increases in volume.

Therefore, it would be advantageous to have an improved method, apparatus and computer instructions for alerting the user to the presence of a call while minimizing the nuisance that a ring tone may cause in a public place.

### SUMMARY OF THE INVENTION

The present invention provides a method, apparatus, and computer instructions for managing alerts. A ring tone is audibly presented to alert the user of the incoming call in response to detecting receipt of the incoming call. A selected movement of the mobile communications device is monitored for in response to audibly presenting the ring tone. The volume of the ring tone is reduced without answering the incoming call in response to detecting the selected movement.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a mobile telephone in which the present invention may be implemented;

FIG. 2 is a block diagram of a camera phone in accordance with a preferred embodiment of the present invention;

FIG. 3 is a diagram illustrating components used in capturing phone movement and reducing a ring tone in accordance with a preferred embodiment of the present invention; and

FIG. 4 is a flowchart of a process for capturing phone movement in managing the presentation of a ring tone in accordance with a preferred embodiment of the present invention.

### DETAILED DESCRIPTION OF THE PREFERRED EMBODIMENT

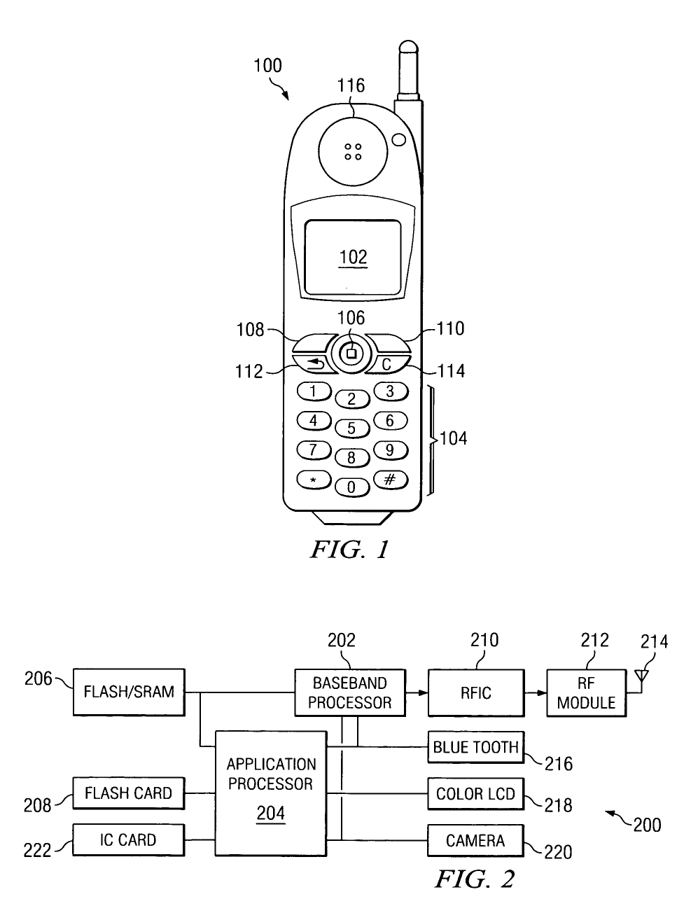

With reference now to the figures and in particular with reference to FIG. 1, a mobile telephone is depicted in which the present invention may be implemented. Mobile phone 100 includes screen 102, which is capable of displaying pictures and text. Additionally, mobile phone 100 also includes numeric keypad 104, joystick 106, and buttons 108, 110, 112, and 114 placed around joystick 106. These buttons are used to initiate various functions in mobile phone 100. These functions, include for example, activating a menu, displaying a calendar, or initiating a call. Mobile phone 100 also includes camera 116, which may be used to take pictures or videos depending on the implementation.

Turning next to FIG. 2, a block diagram of a camera phone is depicted in accordance with a preferred embodiment of the present invention. Camera phone 200 includes baseband processor 202, application processor 204, flash/static random access memory (SRAM) 206, flash card 208, radio frequency integrated circuit (RFIC) 210, radio frequency (RF) module 212, antenna 214, Blue Tooth unit 216, color liquid display (LCD) 218, camera 220, and IC card 222.

Baseband processor 202 provides for receiver and transmitter operations and is also referred to as a transceiver. In particular, baseband processor 202 handles all of the audio, signal, and data processing needed to receive and send data using radio frequency (RF) transmissions or Blue Tooth transmissions. Application processor 204 provides the processing power for other functions within camera phone 200. For example, calculators, calendars, alarms, camera functions, and directories are provided through application processor 204. Flash/SRAM 206 is a storage device in which various instructions for providing the functions within camera phone 200 are located and provide upgrades. Flash card 208 is a storage device in which user data and applications may be stored. An example of flash card 208 is a secure digital card.

A pathway for the transmission of voice and other types of data is through RFIC 210. Additionally, short range transmissions may be sent or received through Blue Tooth unit 216. Blue Tooth unit 216 conforms to Blue Tooth application layer for product developers. Both of these transmissions are made through antenna 214 in this illustrative example.

Color LCD 218 provides a display for pictures and other data for camera phone 200. Camera 220, in this example, is a complementary metal oxide semiconductor (CMOS) camera which may be built into camera phone 200 or connected to camera phone 200 as a module, such as IC card 222. IC card 222 also may contain other application specific functions, such as a global positioning system (GPS) or other functions, such as a modem or additional memory.

Camera 220 forms the camera module of camera phone 200, while the other components form the digital phone module of camera phone 200 in these illustrative examples. Instructions or circuits are added to camera phone 200 to capture movement of camera phone 200. In particular, a mechanism is included to recognize that a user is in the process of answering a call received by camera phone 200. The mechanism recognizes when the user no longer needs to be bothered with a ring tone by detecting a phone movement that is indicative of the user being in the process of answering the call.

The present invention provides a method, apparatus, and computer instructions for detecting When a user is in the act of answering a call, but before actually answering the call. In these illustrative examples, a call is answered when the user returns a signal from the mobile phone indicating that the call is to be answered, such as a SS7 ANSWER message. SS7 is a messaging standard used in mobile communications. In this example, the signal may be generated when the user pushes a selected button on the mobile phone.

The present invention recognizes that at that point, a user no longer needs to hear the ringer and reduces the volume of the ring tone. The mechanism of the present invention captures the beginning of the answering process and initiates an action, such as turning down the ring tone to a point where the ringer is even shut off. The mechanism of the present invention captures or detects the answering of a call by detecting some selected type of movement of the mobile phone. This movement may be a jarring action on the mobile phone that occurs within some selected period of time after a ring tone is presented. Alternatively, the movement may be the disconnecting the mobile phone from a specialized belt clip.

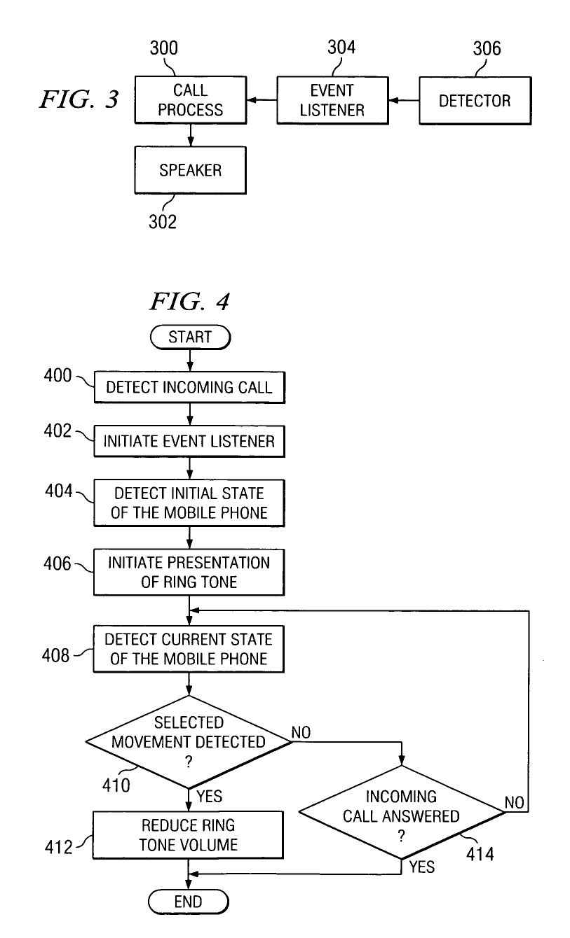

With reference next to FIG. 3, a diagram illustrating components used in capturing phone movement and reducing a ring tone is depicted in accordance with a preferred embodiment of the present invention. The components illustrated in FIG. 3 are logical components that may found within a mobile communications device, such as camera phone 200 in FIG. 2. Call process 300 receives incoming calls and generates ring tones through speaker 302. Additionally, call process 300 may receive signals from event listener 304. Event listener 304 is a component employed to detect or capture the beginning of an answering process prior to the call being actually answered.

In these examples, the earliest moment that one can assume that a user knows the call is being initiated is when the user actually picks up the phone.

This movement may be captured by detector 306. Detector 306 may take various forms, such as, for example, an acceleromator. Detector 306 also may be a contact to a specialized belt clip in which a circuit is broken when the mobile phone is removed from the belt clip.

When detector 306 generates a signal indicating that a selective movement has been detected, the event listener 304 sends a message to call process 300. This message indicates that a movement indicating that a call is being answered has occurred. At that point, call process 300 reduces the volume of the ring tone through speaker 302. This reduction in volume may include shutting off the ring tone entirely.

Additionally, call process 300 only shuts off the ring tone when such a message is generated by event listener 304 and a call has been received. When an incoming call occurs, call process 300 processes the call. Event listener 304 identifies the current movement of the mobile phone in these illustrative examples. The current movement also is referred to as the current state. The current movement may be, for example, still and motionless, vibrating, falling or opening of a flip phone.

Call process 300 generates a ring tone through speaker 302. Event listener 304 waits for a signal to indicate that the user is in the process of answering the call, but prior to the call actually being answered. When the user reaches for the phone on a belt clip or in a purse, the event listener 304 captures the act of the user grabbing the phone. In these illustrative examples, this capture is either a detection of the physical disconnection from the phone device, such as a belt clip or from a motion detector within the mobile phone. This movement is compared to the current state of the phone. If the state has changed, event listener 304 sends a signal to call process 300, which in turn assumes that the user was notified of the call and recognized the incoming call was present. The ringer is then turned down or off by call process 300.

In reference to FIG. 4, a flowchart of a process for capturing phone movement in managing the presentation of a ring tone is present in accordance with the preferred embodiment of the present invention. The process illustrated in FIG. 4 may be implemented in a mobile phone, such as camera phone 200 in FIG. 2.

The process begins by detecting incoming call (step 400). Upon detecting the incoming call at the mobile phone, an event listener is initiated (step 402). The event listener is a component, such as event listener 304 in FIG. 3. The initial state of the mobile phone is then identified through the event listener 304 (step 404). The current state may be, for example, still motionless, vibrating as if in a car, or falling as if downward movement in an elevator. Thereafter, the ring tone is presented (step 406). The current state of the mobile phone is detected (step 408). The state may be detected using a sensor.

Next, a determination is made as to whether a selected movement has been detected (step 410). The selected movement is identified by comparing the state of the mobile phone when the incoming call is received with the current state. In step 408, the selected movement may be detected when the difference between the initial state of the mobile phone at the time the incoming call was received differs from the current movement state of the mobile phone in an amount that exceeds threshold value.

The initial state of the mobile phone in step 404 may be, for example, a vibrating state. If movement, such as a vibration of a phone on a seat in a car is detected, that movement is stored as a current movement. If the initial state of the mobile phone as detected by the sensor changes to a still state, such as one when the user picks up the phone from the car seat, then the selected movement is identified. At this point, the mobile phone is considered to be in the process of being answered by the user.

In another example, the initial state of the mobile phone may have been a state in which the mobile phone is still. A movement of the mobile phone in an upward direction may indicate that the mobile phone has been picked up by the user. The threshold may require some amount of upward movement before the selected movement is determined to have been detected.

If the selected movement has been detected, the ring tone volume is reduced (step 412) with the process terminating thereafter. With reference again to step 408, the selected movement has not been detected, a determination is made as to whether the incoming call has been answered (step 414). If the incoming call has not been answered, the process returns to step 408 to detect the state of the mobile phone.

As mentioned before, the process loops back to step 408 to detect the current state of the mobile phone at that time. This current state is compared with the previously detected initial state in step 404 to determine whether a selected movement has occurred as described with respect to step 410 in these illustrative examples.

The selected movement may be, for example, removing the mobile phone from a belt clip. When the mobile phone is connected to the belt clip, a contact is made and a complete circuit forms. This circuit is used to identify the current state of the mobile phone. When the mobile phone is removed from the belt clip, the circuit is now opened. As a result, the state changes to identify the selected movement. A similar determination is made with respect to a motion detector, as described above. Additionally, another example of a change in state is the opening of a flip phone a closed position. If a flip phone is opened after a ring tone has been presented, the mechanism of the present invention does not answer the call. Instead, the ring tone is reduced or eliminated.

Thus, the present invention provides an improved method, apparatus and computer instructions for reducing the volume of silencing a ring tone for a mobile phone based upon a movement of the mobile phone after an incoming call has been received. The mechanism of the present invention detects the current movement state of the mobile phone, activates the ring tones of the mobile phone, and monitors the movement of the mobile phone from the current movement state. The ring tone is reduced in volume if the movement exceeds a threshold. This reduction in volume may include silencing the ring tone.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a mobile communications device for managing alerts, the method comprising:
responsive to detecting receipt of an incoming call, audibly presenting a ring tone to alert a user of the incoming call;
monitoring the mobile communications device for a selected movement of the mobile communications device in response to audibly presenting the ring tone; and
responsive to detecting the selected movement, reducing a volume of the ring tone without answering the incoming call.

2. The method of claim 1, wherein the monitoring step monitors for the selected movement by monitoring for a selected signal and wherein the selected signal is generated with the mobile communications device is removed from a belt clip.

3. The method of claim 1, wherein the monitoring step comprises:
monitoring a connection to a motion detector for a signal indicating an occurrence of the selected movement.

4. The method of claim 1, wherein the motion detector is at least one of an accelerometer and a gyroscope.

5. The method of claim 1, wherein mobile communications device is a flip phone and wherein the selected movement is an opening of the flip phone.

6. The method of claim 1, wherein the selected movement is a jarring action applied to the mobile communications device.

7. The method of claim 1, wherein the reducing step halts presenting of the ring tone.

8. A data processing system in a mobile communications device for managing alerts, the data processing system comprising:
presenting means, responsive to detecting receipt of an incoming call, for audibly presenting a ring tone to alert a user of the incoming call;
monitoring means for monitoring the mobile communications device for a selected movement of the mobile communications device in response to audibly presenting the ring tone; and
reducing means, responsive to detecting the selected movement, for reducing a volume of the ring tone without answering the incoming call.

9. The data processing system of claim 8, wherein the monitoring means monitors for the selected movement by monitoring for a selected signal and wherein the selected signal is generated with the mobile communications device is removed from a belt clip.

10. The data processing system of claim 8, wherein the monitoring means comprises:
means for monitoring a connection to a motion detector for a signal indicating an occurrence of the selected movement.

11. The data processing system of claim 8, wherein the motion detector is at least one of an accelerometer and a gyroscope.

12. The data processing system of claim 8, wherein mobile communications device is a flip phone and wherein the selected movement is an opening of the flip phone.

13. The data processing system of claim 8, wherein the selected movement is a jarring action applied to the mobile communications device.

14. The data processing system of claim 8, wherein the reducing means halts presenting of the ring tone.

15. A computer program product in a computer readable medium for managing alerts, the computer program product comprising:
first instructions, responsive to detecting receipt of an incoming call, for audibly presenting a ring tone to alert a user of the incoming call;
second instructions for monitoring the mobile communications device for a selected movement of the mobile communications device in response to audibly presenting the ring tone; and
third instructions, responsive to detecting the selected movement, for reducing a volume of the ring tone without answering the incoming call.

16. The computer program product of claim 15, wherein the second instructions monitors for a selected signal and wherein the selected signal is generated with the mobile communications device is removed from a belt clip.

17. The computer program product of claim 15, wherein the second instructions for monitoring comprises:
sub-instructions for monitoring a connection to a motion detector for a signal indicating an occurrence of the selected movement.

18. The method of claim 15, wherein the motion detector is at least one of an accelerometer and a gyroscope.

19. The method of claim 15, wherein mobile communications device is a flip phone and wherein the selected movement is an opening of the flip phone.

20. The method of claim 15, wherein the selected movement is a jarring action applied to the mobile communications device.

21. The method of claim 15, wherein the third instructions for reducing halts presenting of the ring tone.
